(19) United States
(12) Patent Application Publication
(10) Pub. No.: US 2025/0358682 A1
(43) Pub. Date: Nov. 20, 2025

(54) UWB-BASED ACCESS CONTROL MODE CONFIGURATIONS

(71) Applicant: Schlage Lock Company LLC, Carmel, IN (US)

(72) Inventors: Ryan C. Kincaid, Indianapolis, IN (US); David Brown, New Palestine, IN (US); Joseph Land, Danville, IN (US)

(21) Appl. No.: 18/665,055

(22) Filed: May 15, 2024

(51) Int. Cl. H04W 28/086; H04W 28/08

(52) U.S. Cl. CPC H04W 28/086; H04W 28/0867

(57) ABSTRACT

A method for configuration of an ultra-wideband-based access control mode of an access control device according to an embodiment includes determining, by a computing system, whether to configure the ultra-wideband-based access control mode for the access control device, receiving, by the computing system, a user selection of a configuration type for the ultra-wideband-based access control mode in response to determining to configure the ultra-wideband-based access control mode for the access control device, performing, by the access control device, automated configuration of the ultra-wideband-based access control mode in response to determining that user selection of the configuration type is an automated configuration, and storing, by the access control device, manual configuration settings received from the user in response to determining that the user selection of the configuration type is a manual configuration.

### BACKGROUND

Access control systems typically involve the use of credentials to manage the operation of an access control device (e.g., a lock device). Such credentials may be assigned to a particular user or device and are often physical in nature, forming at least a portion of, for example, a smartcard, proximity card, key fob, or token device. Thus, credential systems generally require an interaction between the credential and a reader device (e.g., on or secured to the access control device) such that the reader device may read the credential and determine whether access should be granted. In particular, a user may be required to swipe, tap, or otherwise present the credential to the reader device. As such, access control systems often require an active physical action on behalf of the user in order to grant the user access via the access control device.

### SUMMARY

One embodiment is directed to a unique system, components, and methods for UWB-based access control mode configurations. Other embodiments are directed to apparatuses, systems, devices, hardware, methods, and combinations thereof for UWB-based access control mode configurations.

According to an embodiment, a method for configuration of an ultra-wideband-based access control mode of an access control device may include determining, by a computing system, whether to configure the ultra-wideband-based access control mode for the access control device, receiving, by the computing system, a user selection of a configuration type for the ultra-wideband-based access control mode in response to determining to configure the ultra-wideband-based access control mode for the access control device, performing, by the access control device, automated configuration of the ultra-wideband-based access control mode in response to determining that user selection of the configuration type is an automated configuration, and storing, by the access control device, manual configuration settings received from the user in response to determining that the user selection of the configuration type is a manual configuration.

In some embodiments, receiving the user selection of the configuration type for the ultra-wideband-based access control mode may include receiving the user selection of the configuration type via a mobile device of the user, wherein a wireless communication connection is established between the mobile device and the access control device.

In some embodiments, the method may further include receiving the manual configuration settings from the user via user input on a mobile device of the user.

In some embodiments, the manual configuration settings may include a user selection of an enabled field of view of an ultra-wideband antenna of the access control device.

In some embodiments, the enabled field of view of the ultra-wideband antenna of the access control device may be user-selected via interaction with a plurality of discrete field of view regions, wherein user selection of each discrete field of view region of the plurality of field of view regions toggles a status of the respective discrete field of view region between enabled and disabled.

In some embodiments, the discrete field of view regions may form a grid system.

In some embodiments, the enabled field of view of the ultra-wideband antenna of the access control device may be adjustable by the user modifying the angular bounds of a displayed field of view indicator.

In some embodiments, the method may further include receiving the manual configuration settings from the user via a user interface on the access control device.

In some embodiments, the method may further include receiving the manual configuration settings from the user as a user selection of one of a plurality of predefined manual configuration settings.

In some embodiments, performing the automated configuration of the ultra-wideband-based access control mode may include receiving radio detection and ranging (RADAR) data based on a physical environment of the access control device, and configuring a field of view of an ultra-wideband antenna of the access control device based on the RADAR data.

In some embodiments, performing the automated configuration of the ultra-wideband-based access control mode may include generating a heat map indicative of a frequency of positive intent approaches of users to the access control device, and configuring a field of view of an ultra-wideband antenna of the access control device based on the heat map.

In some embodiments, performing the automated configuration of the ultra-wideband-based access control mode may include performing intent detection during a learning phase to increase an enabled field of view of an ultra-wideband antenna of the access control device from an initial enabled field of view in response to determining that a positive intent session has occurred when the user is outside of the initial enabled field of view.

In some embodiments, performing the intent detection during the learning phase may include performing the intent detection during a learning phase of a predefined number of positive intent sessions.

According to another embodiment, a computing system for configuration of an ultra-wideband-based access control mode of an access control device may include at least one processor and at least one memory comprising a plurality of instructions stored thereon that, in response to execution by the at least one processor, cause the computing system to determine whether to configure the ultra-wideband-based access control mode for the access control device, receive a user selection of a configuration type for the ultra-wideband-based access control mode in response to a determination to configure the ultra-wideband-based access control mode for the access control device, perform automated configuration of the ultra-wideband-based access control mode in response to a determination that user selection of the configuration type is an automated configuration, and store manual configuration settings received from the user in response to a determination that the user selection of the configuration type is a manual configuration.

In some embodiments, the method may further include receiving the manual configuration settings from the user via user input on a mobile device of the use, wherein the manual configuration settings comprise a user selection of an enabled field of view of an ultra-wideband antenna of the access control device.

In some embodiments, the enabled field of view of the ultra-wideband antenna of the access control device may be user-selected via interaction with a plurality of discrete field of view regions, wherein user selection of each discrete field of view region of the plurality of field of view regions toggles a status of the respective discrete field of view region between enabled and disabled.

In some embodiments, performing the automated configuration of the ultra-wideband-based access control mode may include receiving radio detection and ranging (RADAR) data based on a physical environment of the access control device, and configuring a field of view of an ultra-wideband antenna of the access control device based on the RADAR data.

In some embodiments, performing the automated configuration of the ultra-wideband-based access control mode may include generating a heat map indicative of a frequency of positive intent approaches of users to the access control device, and configuring a field of view of an ultra-wideband antenna of the access control device based on the heat map.

In some embodiments, performing the automated configuration of the ultra-wideband-based access control mode may include performing intent detection during a learning phase to increase an enabled field of view of an ultra-wideband antenna of the access control device from an initial enabled field of view in response to determining that a positive intent session has occurred when the user is outside of the initial enabled field of view.

In some embodiments, performing the intent detection during the learning phase may include performing the intent detection during a learning phase of a predefined number of positive intent sessions.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of an access control system for configuration of an ultra-wideband-based access control mode;

FIG. 2 is a simplified block diagram of at least one embodiment of a computing device;

FIG. 3 is a simplified flow diagram of at least one embodiment of a method for configuration of an ultra-wideband-based access control mode;

FIG. 4 is a simplified illustration of exemplary sensitivity options for an ultra-wideband-based access control mode;

FIG. 5 is a simplified illustration of alternative sensitivity options for an ultra-wideband-based access control mode;

FIG. 6-10 are simplified illustrations of various embodiments of user-adjustable field of view configurations for an ultra-wideband-based access control mode;

FIG. 11 is a simplified illustration of exemplary floorplan-based configuration options for an ultra-wideband-based access control mode;

FIGS. 12-13 are a simplified flow diagram of at least one embodiment of a method for automated learning of a configuration for an ultra-wideband-based access control mode;

FIG. 14 is a simplified illustration of automated determination of a configuration for an ultra-wideband-based access control mode based on radio detection and ranging (RADAR) data; and

FIG. 15 is a simplified illustration of an exemplary heat map used for automated configuration of an ultra-wideband-based access control mode.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

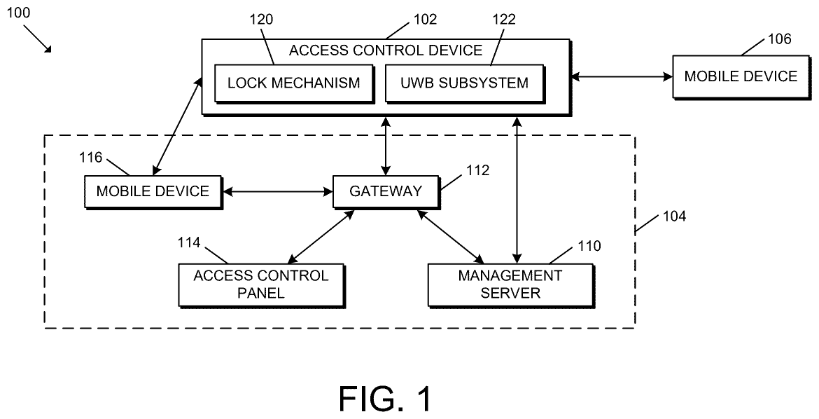

Referring now to FIG. 1, in the illustrative embodiment, an access control system 100 for configuration of an ultra-wideband-based access control mode is shown. The illustrative access control system 100 includes an access control device 102, a management system 104, and a mobile device 106. Further, the management system 104 may include a management server 110, a gateway device 112, an access control panel 114, and/or a mobile device 116. Further, as shown, the illustrative access control device 102 includes a lock mechanism 120 and a UWB subsystem 122. However, in other embodiments, it should be appreciated that the access control device 102 may be embodied as a UWB accessory device configured to perform or facilitate the UWB-based intent detection described herein, which may be communicatively coupled to an electronic lock including a lock mechanism (e.g., such as the lock mechanism 120).

As described in detail below, the access control device 102 may control and/or facilitate access to a passageway (e.g., through a doorway) via a lock mechanism 120 based on the location of the mobile device 106 (e.g., a UWB-capable smartphone, smartwatch, or wearable device) determined from UWB communication signals (UWB data) received from the mobile device 106 and one or more intent criteria. In particular, the access control device 102 may receive UWB data from the UWB subsystem 122 related to a UWB ranging session with the mobile device 106 and indicative of a distance of the mobile device 106 from the access control device 102 and an angle of arrival (AoA) of UWB signals received from the mobile device 106. The access control device 102 may perform various analyses on the UWB data and infer ingress intent of a user of the mobile device 106 if the UWB data satisfies the relevant intent criteria (e.g., being within a threshold distance of the access control device 102, within angular thresholds, or other geometrically defined area for at least a certain amount of time). If ingress intent is inferred, in some embodiments, the access control device 102 may automatically control the lock mechanism 120 without requiring user input or a physical action by the user (e.g., to unlock the lock mechanism 120). In other embodiments, the access control device 102 may control the lock mechanism 120 only if additional intent criteria are satisfied that require user interaction (e.g., the user making a particular gesture such as a hand wave, a tap on the mobile device 106, and/or other intent criteria). It should be further appreciated that a user (e.g., a homeowner) may utilize a user interface (e.g., on the user's mobile device 106, on the access control device 102, etc.) in order to select and/or configure the UWB-based access control mode.

It should be appreciated that the access control device 102, the management system 104, the mobile device 106, the management server 110, the gateway device 112, the access control panel 114, and/or the mobile device 116 may be embodied as any type of device or collection of devices suitable for performing the functions described herein.

More specifically, in the illustrative embodiment, the access control device 102 may be embodied as any type of device capable of controlling and/or facilitating access through a passageway (e.g., at least in part). For example, in various embodiments, the access control device 102 may be embodied as an electronic lock (e.g., a mortise lock, a cylindrical lock, or a tubular lock), an exit device (e.g., a pushbar or pushpad exit device), a door operator, an auto-operator, a motorized latch/bolt (e.g., for a sliding door), a barrier control device (e.g., battery-powered), or a peripheral controller of a barrier to a passageway. Accordingly, in some embodiments, the access control device 102 may include a lock mechanism 120 configured to be positioned in a locked state in which access to the passageway is denied, or positioned in an unlocked state in which access to the passageway is permitted. In some embodiments, the lock mechanism 120 includes a deadbolt, latch bolt, lever, strike, and/or other mechanism adapted to move between the locked and unlocked state and otherwise perform the functions described herein. However, it should be appreciated that the lock mechanism 120 may be embodied as any another mechanism suitable for controlling access through a passageway in other embodiments.

Depending on the particular embodiment, the access control device 102 may include a credential reader or be electrically/communicatively coupled to a credential reader configured to communicate with the mobile device 106 and/or other credential devices. In some embodiments, the access control device 102 may have an access control database stored thereon for locally performing access control decisions associated with user access. Accordingly, in such embodiments, the access control database may store credential data, biometric data, historical information, PINs, passcodes, and/or other relevant authentication data associated with users. In other embodiments, such data or a portion thereof may be stored in a centralized access control database (e.g., hosted by and/or accessible to the management server 110).

As described herein, the access control device includes a UWB subsystem 122 for performing UWB ranging with other UWB-capable devices (e.g., the mobile device 106). The UWB subsystem 122 includes one or more UWB antennas (e.g., a plurality of UWB antennas) for wireless communication using UWB technology (e.g., using the IEEE 802.15.4 (wireless) standard). It should be appreciated that a UWB signal may be received by multiple UWB antennas, and the UWB subsystem 122 of the access control device 102 may calculate or estimate the distance and angle of arrival of the mobile device 106 based on the received UWB signal. It should be further appreciated that the number, size, and/or arrangement of UWB antennas of the UWB subsystem 122 may vary depending on the particular embodiment. Further, it should be appreciated that the access control device 102 may also include other wireless communication circuitry for communicating with the mobile device 106 and/or other devices via corresponding protocols (e.g., Wi-Fi, Bluetooth (e.g., including BLE), Zigbee, Z-Wave, Near Field Communication (NFC), Thread, etc.). For example, in some embodiments, the mobile device 106 and/or the access control device 102 may perform a Bluetooth High Accuracy Distance Measurement (HADM) based on Bluetooth communication signals transmitted between the mobile device 106 and the access control device 102.

In the illustrative embodiment, the mobile device 106 may be embodied as any mobile device capable of communicating with the access control device 102 via UWB signals (e.g., for UWB ranging), exchanging credential information with the access control device 102, and/or otherwise performing the functions described herein. Accordingly, in some embodiments, in addition to having UWB communication circuitry, it should be appreciated that the mobile device 106 may also include other wireless communication circuitry for communicating with the access control device 102 and/or other devices via corresponding protocols (e.g., Wi-Fi, Bluetooth (e.g., including BLE), Zigbee, Z-Wave, Near Field Communication (NFC), Thread, Matter, etc.). It should be appreciated that, in some embodiments, the mobile device 106 may be embodied as a UWB-enabled smartphone, smartwatch, wearable computing device, UWB fob, or UWB tag device.

As described herein, in some embodiments, the mobile device 106 may be configured to perform the various functions described in addition to or in the alternative to the access control device 102. Further, in some embodiments, the mobile device 106 may leverage sensor data to validate various data and/or otherwise improve the accuracy of the functions described herein. In particular, in some embodiments, the mobile device 106 may include an inertial measurement unit (IMU) including, for example, an accelerometer, gyroscope, and/or magnetometer that generates inertial data associated with the mobile device 106, which may be used to verify the velocity/heading of the mobile device 106. In other embodiments, the mobile device 106 may include environmental sensors (e.g., temperature sensors, air pressure sensors, humidity sensors, light sensors, etc.), inertial sensors (e.g., accelerometers, gyroscopes, etc.), magnetometers, proximity sensors, optical sensors, electromagnetic sensors, audio sensors (e.g., microphones), motion sensors, cameras, piezoelectric sensors, pressure sensors, switches (e.g., reed switches), and/or other types of sensors.

As described herein, the management system 104 may be configured to manage credentials of the access control system 100. For example, the management system 104 may be responsible for ensuring that the access control devices 102 have updated authorized credentials, whitelists, blacklists, device parameters, and/or other suitable data. Additionally, in some embodiments, the management system 104 may receive security data, audit data, raw sensor data, and/or other suitable data from the access control devices 102 for management of the access control system 100. In some embodiments, one or more of the devices of the management system 104 may be embodied as an online server or a cloud-based server. Further, in some embodiments, the management system 104 may communicate with multiple access control devices 102 at a single site (e.g., a particular building) and/or across multiple sites. That is, in such embodiments, the management system 104 may be configured to receive data from access control devices 102 distributed across a single building, multiple buildings on a single campus, or across multiple locations.

It should be appreciated that the management system 104 may include one or more devices depending on the particular embodiment of the access control system 100. For example, as shown in FIG. 1, the management system 104 may include a management server 110, a gateway device 112, an access control panel 114, and/or a mobile device 116 depending on the particular embodiment. The functions of the management system 104 described herein may be performed by one or more of those devices in various embodiments. For example, in some embodiments, the management server 110 may perform all of the functions of the management system 104 described herein. Further, in some embodiments, the gateway device 112 may be communicatively coupled to the access control device 102 such that the other devices of the management system 104 (e.g., the management server 110, the access control panel 114, and/or the mobile device 116) may communicate with the access control device 102 via the gateway device 112.

In some embodiments, the access control device 102 may communicate with the management server 110 over a Wi-Fi connection and/or with the mobile device 116 over a Bluetooth connection. Additionally, the access control device 102 may communicate with the management server 110 and/or the access control panel 114 via the gateway device 112. As such, in the illustrative embodiment, the access control device 102 may communicate with the gateway device 112 over a Wi-Fi connection and/or a Bluetooth connection, and the gateway device 112 may, in turn, forward the communicated data to the relevant management server 110 and/or access control panel 114. In particular, in some embodiments, the gateway device 112 may communicate with the access control panel 114 over a serial communication link (e.g., using RS-485 standard communication), and the gateway device 112 may communicate with the management server 110 over a Wi-Fi connection, an Ethernet connection, or another wired/wireless communication connection. As such, it should be appreciated that the access control device 102 may communicate with the management server 110 via an online mode with a persistent real-time communication connection or via an offline mode (e.g., periodically or in response to an appropriate condition) depending on the particular embodiment (e.g., depending on whether the access control device 102 is offline). As indicated above, in other embodiments, it should be appreciated that the access control device 102 may communicate with the devices of the management system 104 via one or more other suitable communication protocols.

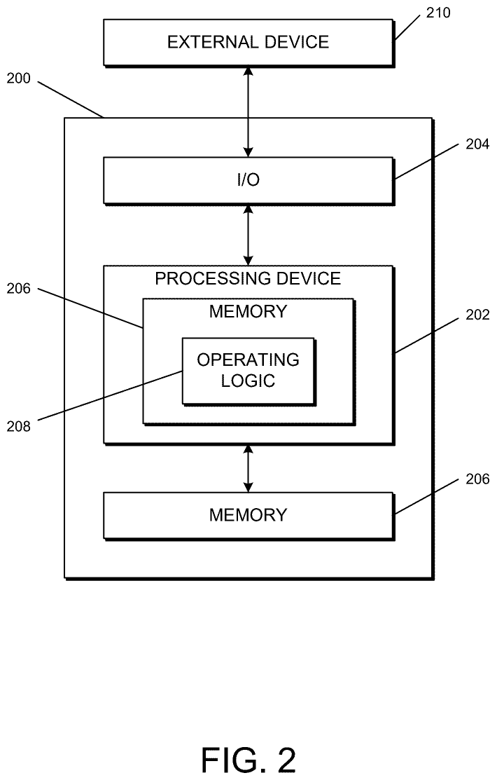

It should be appreciated that each of the access control device 102, the management system 104, the mobile device 106, the management server 110, the gateway device 112, the access control panel 114, and/or the mobile device 116 may be embodied as one or more computing devices similar to the computing device 200 described below in reference to FIG. 2. For example, in the illustrative embodiment, each of the access control device 102, the management system 104, the mobile device 106, the management server 110, the gateway device 112, the access control panel 114, and the mobile device 116 includes a processing device 202 and a memory 206 having stored thereon operating logic 208 for execution by the processing device 202 for operation of the corresponding device.

It should be further appreciated that, although the management system 104 and the management server 110 are described herein as one or more computing devices outside of a cloud computing environment, in other embodiments, the system 104 and/or server 110 may be embodied as a cloud-based device or collection of devices. Further, in cloud-based embodiments, the system 104 and/or server 110 may be embodied as a “serverless” or server-ambiguous computing solution, for example, that executes a plurality of instructions on-demand, contains logic to execute instructions only when prompted by a particular activity/trigger, and does not consume computing resources when not in use. That is, the system 104 and/or server 110 may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system 104 and/or server 110 described herein. For example, when an event occurs (e.g., data is transferred to the system 104 and/or server 110 for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of updated access control data is made by a user (e.g., via an appropriate user interface to the system 104 or server 110), the appropriate virtual function(s) may be executed to perform the actions before eliminating the instance of the virtual function(s).

Although only one access control device 102, one management system 104, one mobile device 106, one management server 110, one gateway device 112, one access control panel 114, and one mobile device 116 are shown in the illustrative embodiment of FIG. 1, the system 100 may include multiple access control devices 102, management systems 104, mobile devices 106, management servers 110, gateway devices 112, access control panels 114, and/or mobile devices 116 in other embodiments. For example, as indicated above, the server 110 may be embodied as multiple servers in a cloud computing environment in some embodiments. Further, each user may be associated with one or more separate mobile devices 106 in some embodiments.

Referring now to FIG. 2, a simplified block diagram of at least one embodiment of a computing device 200 is shown. The illustrative computing device 200 depicts at least one embodiment of an access control device, mobile device, management server, gateway device, and/or access control panel that may be utilized in connection with the access control device 102, the management system 104, the mobile device 106, the management server 110, the gateway device 112, the access control panel 114, and/or the mobile device 116 illustrated in FIG. 1. Depending on the particular embodiment, computing device 200 may be embodied as a reader device, credential device, access control device, UWB-capable device, server, desktop computer, laptop computer, tablet computer, notebook, netbook, Ultrabook™, mobile computing device, cellular phone, smartphone, wearable computing device, personal digital assistant, Internet of Things (IoT) device, control panel, processing system, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as the access control device 102, the management system 104, the mobile device 106, the management server 110, the gateway device 112, the access control panel 114, and/or the mobile device 116. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is of a programmable variety that executes algorithms and/or processes data in accordance with operating logic 208 as defined by programming instructions (such as software or firmware) stored in memory 206. Additionally, or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable variety, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

It should be appreciated that the system 100 may utilize one of various different UWB-based modes of entry described herein to gain access through the access control device 102 based on UWB data (e.g., indicative of the location of the mobile device 106 relative to the access control device 102) and satisfaction of one or more intent criteria associated with the corresponding mode of entry. It should be further appreciated that the system 100 may utilize one or more “fallback” or “backup” UWB-based modes of entry, for example, in circumstances in which the primary mode is unsuccessful or inconclusive. For example, in some embodiments, the system 100 may utilize a “go” mode as a primary mode and a “wait and go” mode as a fallback or backup mode. In other embodiments, one or more other modes may be used as an alternate, fallback, or backup mode (e.g., “touch and go” mode, “tap and go” mode, “double tap and go” mode,” etc.). It should be appreciated that the names of the particular UWB-based modes of entry used in this disclosure (e.g., “touch and go” mode, “tap and go” mode, “wait and go” mode, “go” mode, “double tap and go” mode, etc.) are for reference only and not intended to limit the disclosure.

The “go” mode may be embodied as an “auto unlock on approach” mode of algorithm operation. For example, the mobile device 106 may be in the user's hand, in the user's pocket, in a backpack, handbag, or satchel carried by the user, or otherwise in the user's possession. The lock mechanism 120 (e.g., deadbolt) is unlocked when the user's location, trajectory, and/or other motion (inferred based on such characteristics of the mobile device 106) is indicative of the user's intent to use/access the access control device 102. When using the “wait and go” mode, the lock mechanism 120 is unlocked when the mobile device 106 is within a predefined (e.g., configurable) distance (e.g., 3 feet) from the access control device 102 or another predefined reference point (e.g., the center of the door), or within some other predefined region (e.g., with a configurable geometry), for a threshold period of time (e.g., 3 seconds). When using the “double tap and go” mode, the lock mechanism 120 is unlocked when the mobile device 106 is within a predefined distance from the access control device 102 or within some other predefined geometric region, and the user signals intent by interacting with the mobile device 106 one or more times as the user approaches the access control device 102 (e.g., by double tapping the mobile device 106 within the user's pocket). When using the “touch and go” mode, the lock mechanism 120 is unlocked when the user signals intent by touching or interacting with the access control device 102, such as via a gesture (e.g., a hand wave), while the mobile device 106 is within a predefined (e.g., configurable) distance (e.g., 2-3 feet) from the access control device 102 or another predefined reference point (e.g., the center of the door).

Although the techniques shown and described herein are primarily in reference to two-dimensional determinations, it should be appreciated that three-dimensional data may be used in some embodiments. For example, in some circumstances, the elevation of the mobile device 106 may skew various data. Accordingly, in some embodiments, the access control device 102 may project a three-dimensional data point to two-dimensional space (e.g., the plane of the access control device 102 extending outward horizontally) or otherwise convert three-dimensional data points to two-dimensional data points in order to provide further robustness (e.g., during and/or after a calibration phase).

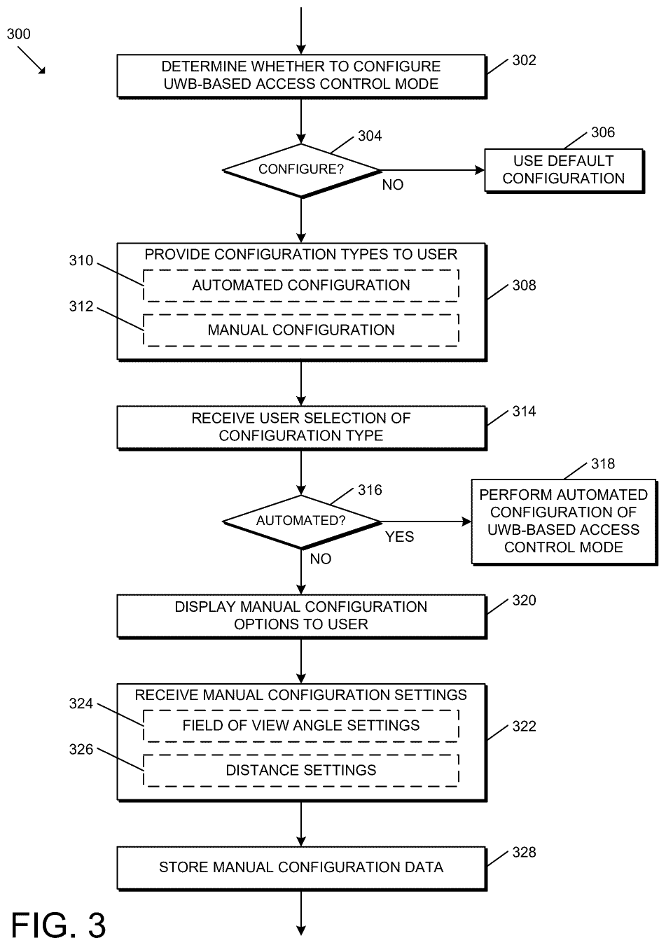

Referring now to FIG. 3, in use, a computing system (e.g., the mobile device 106, the access control device 102, and/or the management system 104) may execute (e.g., in firmware) a method 300 for configuration of a UWB-based access control mode. It should be appreciated that the particular blocks of the method 300 are illustrated by way of example, and such blocks may be combined or divided, added or removed, and/or reordered in whole or in part depending on the particular embodiment, unless stated to the contrary.

The illustrative method 300 begins with block 302 in which the computing system determines whether to configure a UWB-based access control mode for the access control device 102. If the computing system determines not to configure the UWB-based access control mode for the access control device 102, the method 300 advances to block 306 in which the computing system selects or defines a default configuration for the access control device 102. For example, in some embodiments, the computing system may select a configuration with low sensitivity such that the user must be within a relatively near distance and within a narrow field of view relative to the access control device 102.

If the computing system determines, in block 304, to configure the UWB-based access control mode for the access control device 102, the method 300 advances to block 308 in which the computing system may provide one or more configuration types to the user from which to select. In some embodiments, in block 310, the computing system may provide an option for the user to select an automated configuration. Further, in some embodiments, in block 312, the computing system may provide an option for the user to select a manual configuration mode. In block 314, the computing system receives the user selection of the configuration type for the access control device 102. Although the illustrative embodiment describes the selection of a configuration type from a set of multiple configuration types, it should be appreciated that the computing system may only provide one configuration type in some embodiments, in which case blocks 308-314 may be omitted.

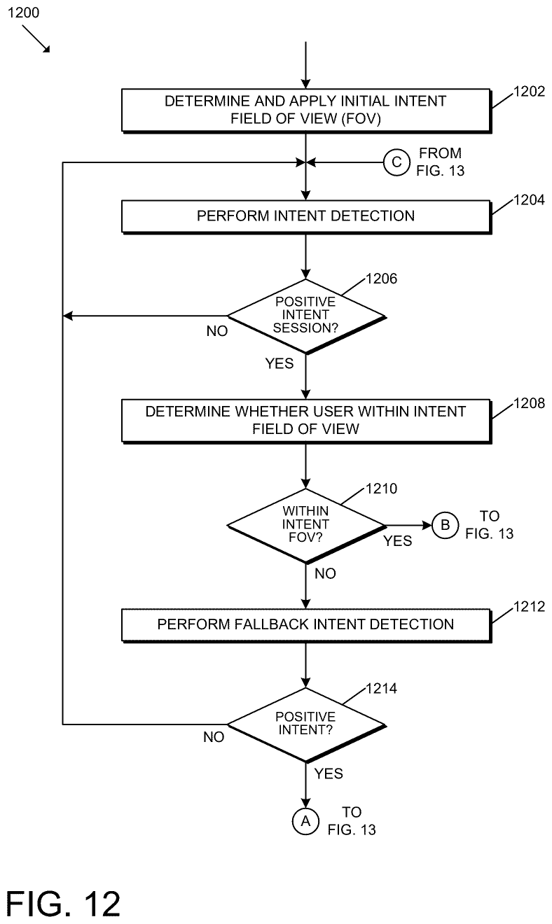

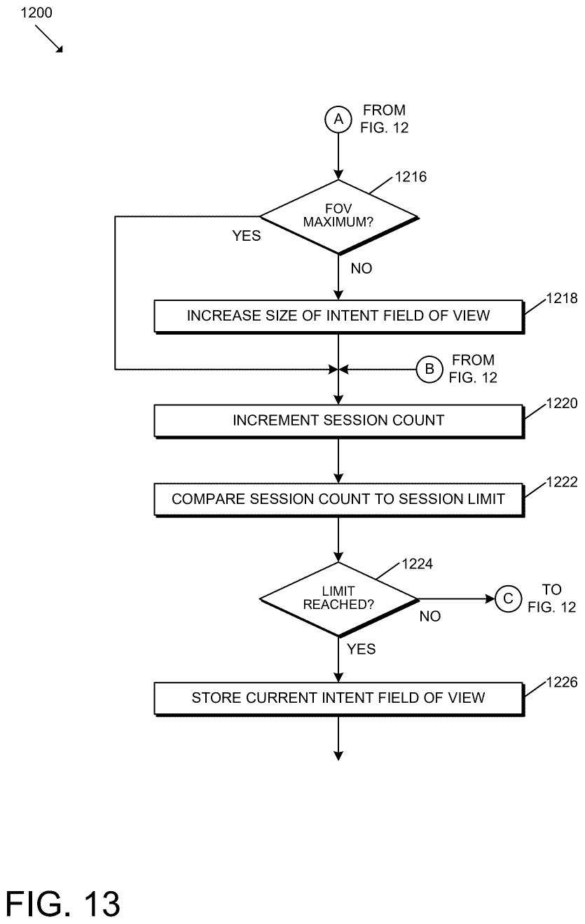

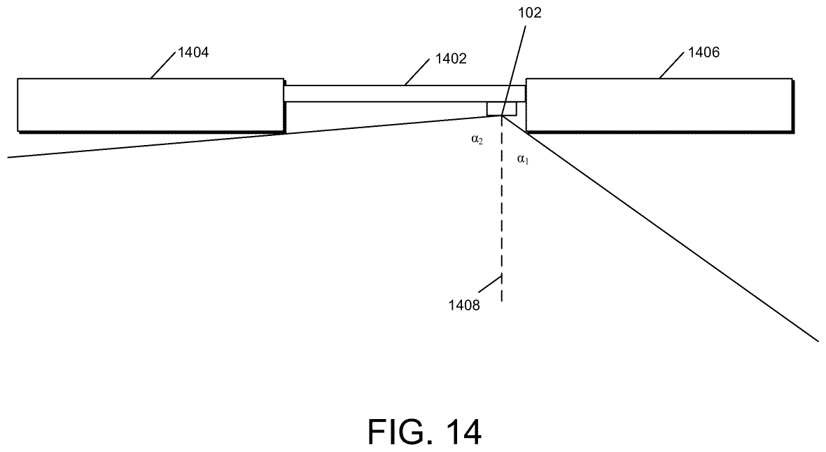

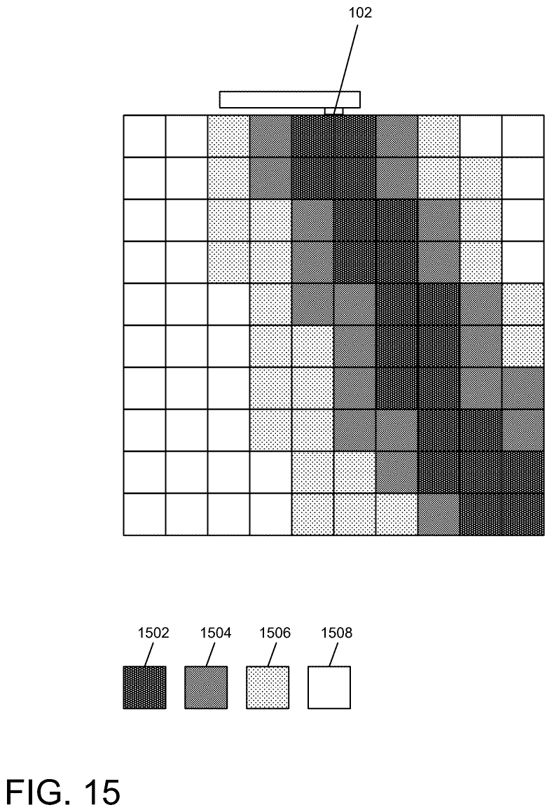

If the computing system determines, in block 316, that the user selected an automated configuration type for the UWB-based access control mode, the method 300 advances to block 318 in which the computing system performs an automated configuration of the UWB-based access control mode. For example, in some embodiments, as described in reference to the method 1200 of FIGS. 12-13, the computing system may begin with an initial (e.g., narrow) enabled intent field of view of the access control device 102, and perform intent detection during a learning phase to increase the enabled field of view of the UWB antenna of the access control device 102 from the initial/current enabled field of view if a positive intent session has occurred when the user is outside of the initial enabled field of view (e.g., by widening the field of view toward the direction from which the user approached the access control device 102). It should be appreciated that the learning phase may including performing a predefined number of ranging sessions or, more specifically, a predefined number of positive intent sessions (e.g., 20), after which the enabled field of view may be defined permanently (or until modified, for example, through another user-prompted learning phase). In other embodiments, as described in reference to FIG. 14, the computing system may receive radio detection and ranging (RADAR) data based on a physical environment of the access control device 102, and configure a field of view of the UWB antenna of the access control device 102 based on the RADAR data. In other embodiments, as described in reference to FIG. 15, the computing system may generate a heat map indicative of a frequency of positive intent approaches of users to the access control device 102, and configure a field of view of the UWB antenna of the access control device 102 based on the heat map. It should be further appreciated that the computing system may otherwise perform automated configuration of the UWB-based access control mode for the access control device 102 in other embodiments.

If the computing system determines, in block 316, that the user selected a manual configuration type for the UWB-based access control mode, the method 300 advances to block 320 in which the computing system displays manual configuration options to user. In block 322, the computing system receives the manual configuration settings selected by the user. In particular, in block 324, the computing system may receive one or more field of view angle settings for the UWB antenna of the access control device 102 and, in block 326, the computing system may receive one or more distance settings for the UWB antenna of the access control device 102. In some embodiments, the manual configuration options/settings are displayed on a graphical user interface of the user's mobile device, such that the user selection may be made on the mobile device 106. The mobile device 106 may establish a wireless communication connection with the access control device 102 to transmit the selected configuration options. In other embodiments, the mobile device 106 may transmit the selected configuration options to the management system 104 which, in turn, may transmit the selected configuration options to the access control device 102. In yet other embodiments, the user may interact directly with an interface on/of the access control device 102 (e.g., via buttons on the access control device 102, etc.) to select and/or modify the configuration options for the UWB-based access control mode. Further, the user may otherwise select/transmit the configuration options to the access control device 102 in other embodiments. In block 328, the manual configuration data is stored on the access control device 102 and/or other devices of the access control system 100.

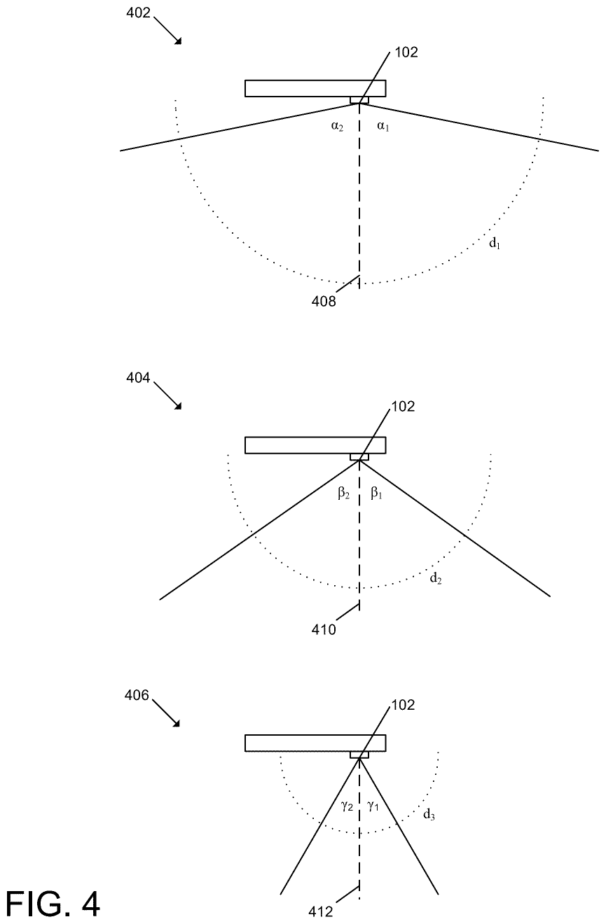

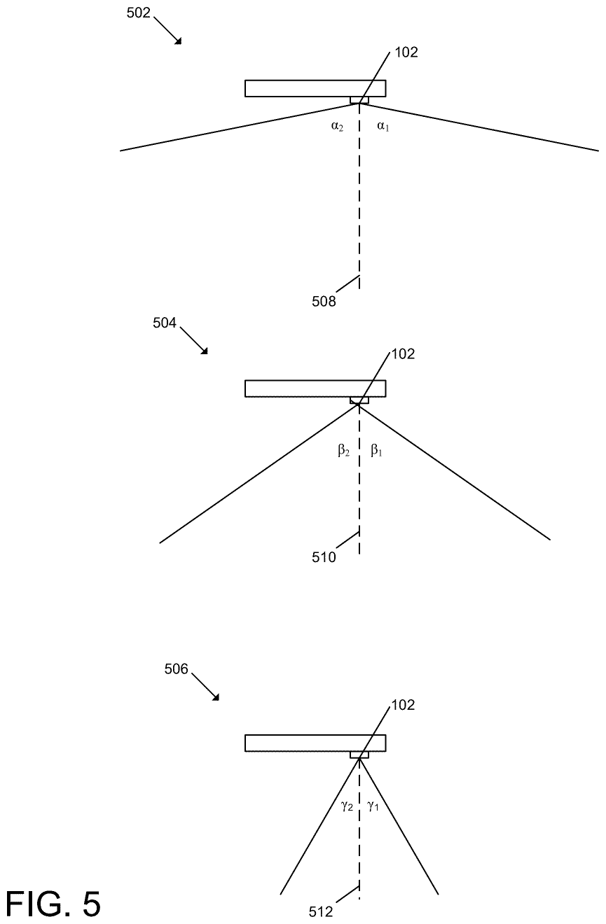

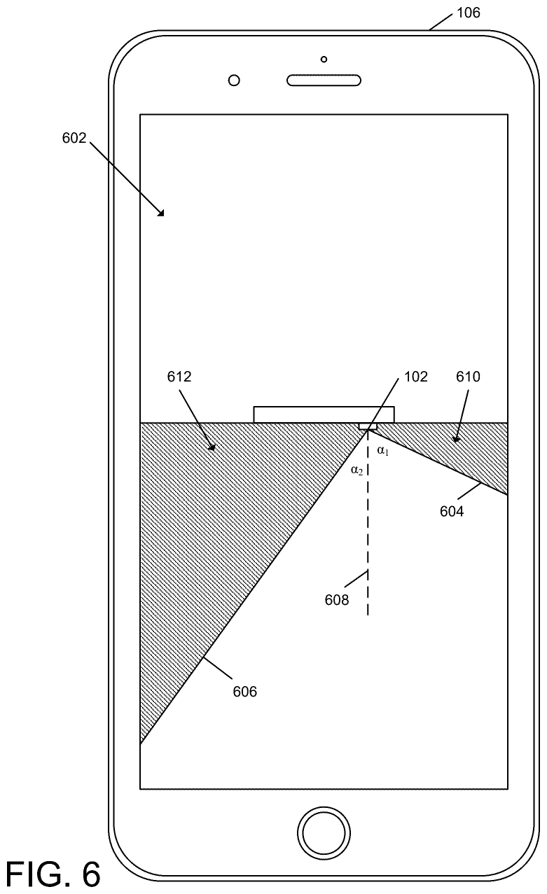

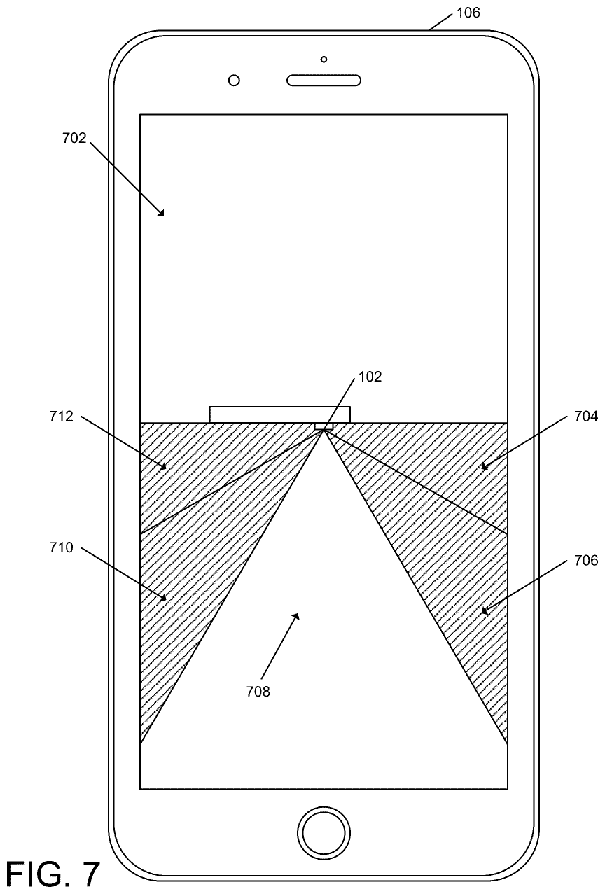

It should be appreciated that the manual configuration options and display thereof may vary depending on the particular embodiment. For example, in some embodiments, the user may select an enabled field of view of the UWB antenna of the access control device 102. In particular, in some embodiments, the user may select the enabled field of view of the UWB antenna of the access control device 102 via interaction with a plurality of discrete field of view regions, such as in embodiments similar to those described in reference to the embodiments of FIGS. 7-10. In other embodiments, the user may select the enabled field of view of the UWB antenna of the access control device 102 by shaping the field of view on a graphical user interface (e.g., by modifying the angular bound of a displayed field of view indicator, such as described in reference to the embodiment of FIG. 6). In yet other embodiments, the user may select the enabled field of view and/or other manual configuration settings from a plurality of predefined manual configuration settings, such as described in reference to the embodiments of FIGS. 4 and 5. It should be further appreciated that the user may otherwise select the manual configuration options in other embodiments.

Although the blocks 302-328 are described in a relatively serial manner, it should be appreciated that various blocks of the method 300 may be performed in parallel and/or in another order in some embodiments.

Referring now to FIG. 4, exemplary sensitivity options for a UWB-based access control mode are shown. FIG. 4 illustrates three different configuration settings 402, 404, 406 for the UWB-based access control mode. In various embodiments, the user may be presented with a slider, dropdown box, radio buttons, and/or other user interface elements to make the user selection. For example, in some embodiments, a slider may be user-adjustable from high sensitivity (e.g., such as depicted by the configuration settings 402) to low sensitivity (e.g., such as depicted by the configuration settings 406). In other embodiments, discrete configuration settings/options are displayed on the user's mobile device 106 from which the user can select a particular configuration. In the illustrative embodiment, the configuration settings 402 include a field of view having angles α₁ and α₂ relative to the center axis 408 and a distance d₁ from the access control device 102, the configuration settings 404 include a field of view having angles β₁ and β₂ relative to the center axis 410 and a distance d₂ from the access control device 102, and the configuration settings 406 include a field of view having angles γ₁ and γ₂ relative to the center axis 412 and a distance d₃ from the access control device 102.

Referring now to FIG. 5, exemplary sensitivity options for a UWB-based access control mode are shown. FIG. 5 illustrates three different configuration settings 502, 504, 506 for the UWB-based access control mode. In various embodiments, the user may be presented with a slider, dropdown box, radio buttons, and/or other user interface elements to make the user selection. For example, in some embodiments, a slider may be user-adjustable from high sensitivity (e.g., such as depicted by the configuration settings 502) to low sensitivity (e.g., such as depicted by the configuration settings 506). In other embodiments, discrete configuration settings/options are displayed on the user's mobile device 106 from which the user can select a particular configuration. In the illustrative embodiment, the configuration settings 502 include a field of view having angles α₁ and α₂ relative to the center axis 508, the configuration settings 504 include a field of view having angles β₁ and β₂ relative to the center axis 510, and the configuration settings 506 include a field of view having angles γ₁ and γ₂ relative to the center axis 512.

Referring now to FIG. 6, a graphical user interface 602 may be displayed on the user's mobile device 106 with a representation of the door and the access control device 102. In the illustrative embodiment, the user may interact with the field of view lines 604, 606 (e.g., by clicking and dragging the lines 604, 606) in order to select the desired field of view of the UWB antenna of the access control device 102. As shown, adjusting the field of view line 604 defines the angle α₁ relative to the center axis 608, and adjusting the field of view line 606 defines the angle α₂ relative to the center axis 608. In the illustrative embodiment, the field of view defined between the field of view lines 604, 606 (i.e., including the angles α₁ and α₂) is enabled, and the field of view regions 610, 612 are disabled.

Referring now to FIG. 7, a graphical user interface 702 may be displayed on the user's mobile device 106 with a representation of the door and the access control device 102. In the illustrative embodiment, the user may interact with the predefined angular/triangular regions 704, 706, 708, 710, 712 to turn those regions on/off for the field of view of the UWB antenna of the access control device 102. In other words, the user selection of one of the predefined angular/triangular regions 704, 706, 708, 710, 712 toggles the status of that selected region between enabled and disabled. In the illustrative embodiment, the predefined angular/triangular region 708 is depicted as being enabled, and the predefined angular/triangular regions 704, 706, 710, 712 are depicted as being disabled.

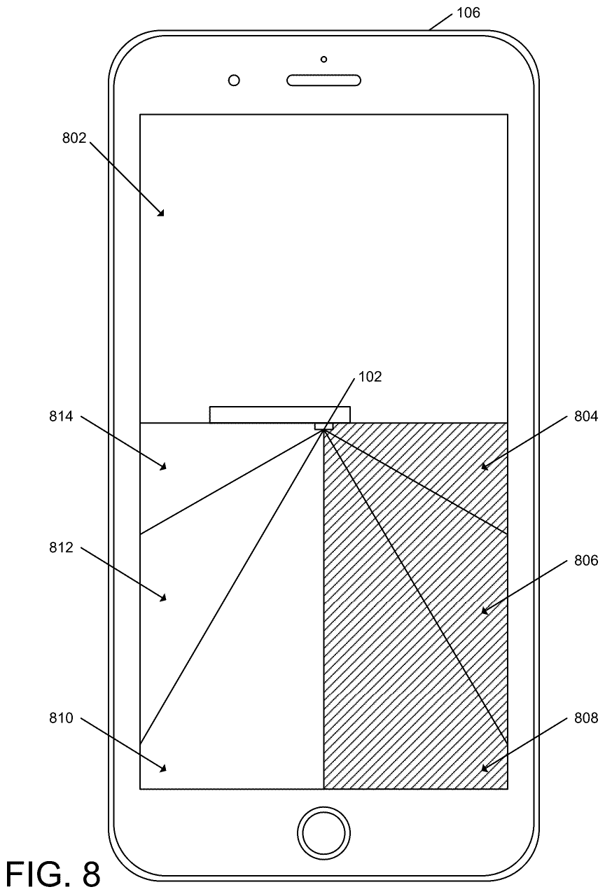

Referring now to FIG. 8, a graphical user interface 802 may be displayed on the user's mobile device 106 with a representation of the door and the access control device 102. Similar to the embodiment of FIG. 7, in the illustrative embodiment of FIG. 8, the user may interact with the predefined angular/triangular regions 804, 806, 808, 810, 812, 814 to enable/disable various regions of the field of view of the UWB antenna of the access control device 102. However, in the illustrative embodiment of FIG. 8, when a user disables a particular region 804, 806, 808, 810, 812, 814, the field of view is inclusively disabled from that selected region 804, 806, 808, 810, 812, 814 toward that side automatically. In other words, if the predefined angular/triangular region 804 is selected to be disabled, then only that region 804 is disabled by virtue of that user selection. However, if the predefined angular/triangular region 806 is selected to be disabled, then both the regions 804, 806 are disabled by virtue of that user selection. And, if the predefined angular/triangular region 808 is selected to be disabled, then all of the regions 804, 806, 808 are disabled by virtue of that user selection. Similarly, if the predefined angular/triangular region 814 is selected to be disabled, then only that region 814 is disabled by virtue of that user selection. However, if the predefined angular/triangular region 812 is selected to be disabled, then both the regions 812, 814 are disabled by virtue of that user selection. And, if the predefined angular/triangular region 810 is selected to be disabled, then all of the regions 810, 812, 814 are disabled by virtue of that user selection.

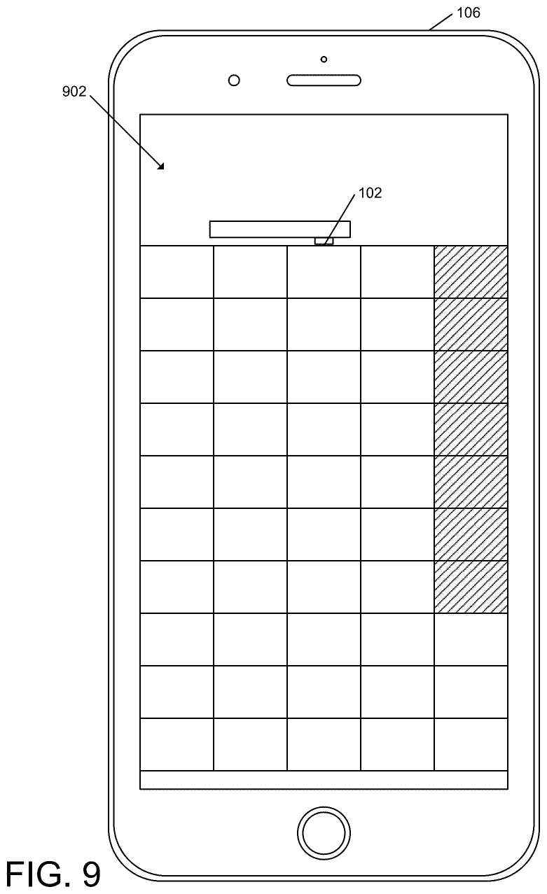

Referring now to FIG. 9, a graphical user interface 902 may be displayed on the user's mobile device 106 with a representation of the door and the access control device 102. Rather than providing the user with predefined angular/triangular regions to be enabled/disabled to affect the field of the view of the UWB antenna of the access control device 102, the graphical user interface 902 may display a grid system with a plurality of grid elements. The illustrative embodiment of FIG. 9 assumes that the field of view is extended to infinity in the direction of the outermost displayed grid elements. As with the embodiment of FIG. 7, the user selection of one of the predefined grid elements toggles the status of that selected grid element between enabled and disabled.

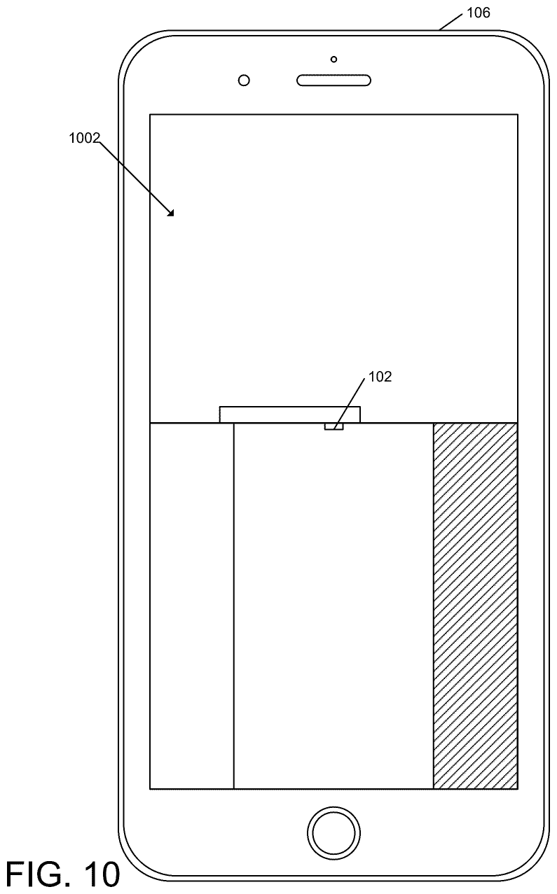

Referring now to FIG. 10, a graphical user interface 1002 may be displayed on the user's mobile device 106 with a representation of the door and the access control device 102. The illustrative embodiment of FIG. 10 is similar to the embodiment of FIG. 9, but with fewer grid elements from which to select for enablement/disablement.

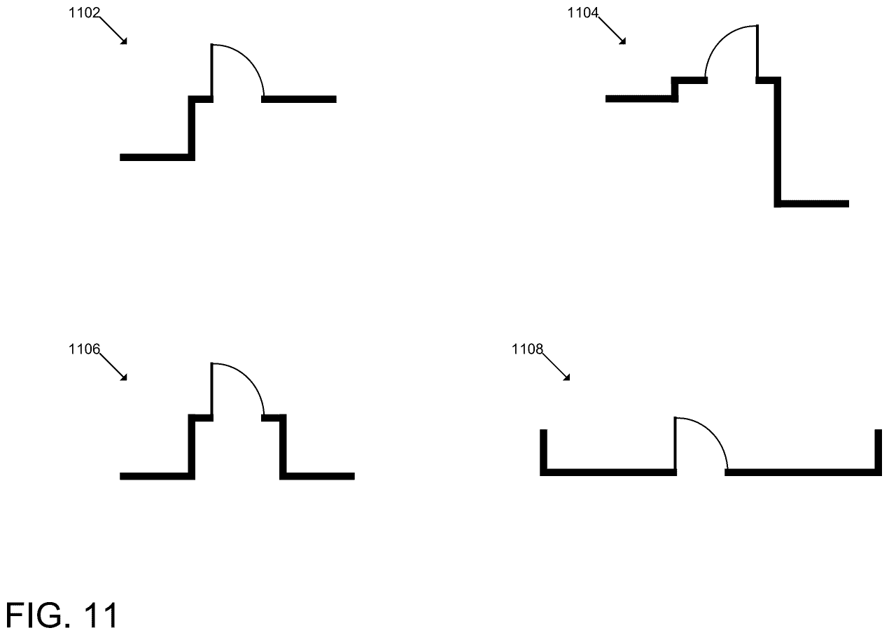

Referring now to FIG. 11, exemplary floorplan-based configuration options for a UWB-based access control mode are shown. FIG. 11 illustrates four different floorplans 1102, 1104, 1106, 1108. In the illustrative embodiment, the user selects the floorplan that most closely resembles the layout at the installation location of the access control device 102. As shown, the floorplan 1102 illustrates an L-shaped left side layout which may correspond with a field of view of the UWB antenna of the access control device 102 in which the left side of the field of view is restricted/disabled. The floorplan 1104 illustrates an L-shaped right side layout which may correspond with a field of view of the UWB antenna of the access control device 102 in which the right side of the field of view is restricted/disabled. The floorplan 1106 illustrates a recessed passageway layout which may correspond with a field of view of the UWB antenna of the access control device 102 in which both the left side and the right side of the field of view are restricted/disabled. The floorplan 1108 illustrates a flat layout which may correspond with a field of view of the UWB antenna of the access control device 102 in which the field of view is not angularly restricted/disabled.

Referring now to FIGS. 12-13, in use, a computing system (e.g., the mobile device 106, the access control device 102, and/or the management system 104) may execute (e.g., in firmware) a method 1200 for automated learning of a configuration for a UWB-based access control mode. It should be appreciated that the particular blocks of the method 1200 are illustrated by way of example, and such blocks may be combined or divided, added or removed, and/or reordered in whole or in part depending on the particular embodiment, unless stated to the contrary.

In the illustrative embodiment, the field of view is “learned” by analyzing the user's approach after each session. The default/starting field of view may be purposefully narrow (e.g., +/−30 degrees). At the end of each session, the computing system may widen the left or right field of view by a predefined amount (e.g., 10 degrees) if the user approach from outside the current field of view and intent was ultimately determined positively. For example, if a user approaches outside of the left field of view and meets the conditions to trigger “wait and go” intent as described above, the left field of view may be increased by 10 degrees, and the updated field of view may be saved in non-volatile memory. This adjustment may occur for each session until the field of view is maximized on that side (e.g., 90 degrees). The learning phase could be limited to the first twenty (or other predefined number of) positive intent sessions, at which point the field of view may become static.

The illustrative method 1200 begins with block 1202 of FIG. 12 in which the computing system determines and applies an initial intent field of view (e.g., the default starting field of view) for the UWB antenna of the access control device 102. It should be appreciated that the initial intent field of view may be purposefully narrow (e.g., +/−30 degrees). In block 1204, the computing system performs intent detection as part of a UWB session (e.g., due to the user being in the vicinity of the access control device 102). If the computing system determines, in block 1206, that the UWB session was not a positive intent session, the method 1200 advances to block 1214. However, if the computing system determines, in block 1206, that the UWB session was a positive intent session, the method 1200 advances to block 1208 in which the computing system determines whether the user was within the current intent field of view. If so, the method 1200 advances to block 1220 of FIG. 13. However, if the computing system determines, in block 1210, that the user was not within the current intent field of view, the method 1200 advances to block 1212 in which the computing system performs fallback intent detection. For example, as described above, in some embodiments, the computing system may perform intent detection via the “wait and go” mode or another mode.

If the computing system determines, in block 1214, that the fallback intent detection is not indicative of positive intent, the method 1200 returns to block 1204. However, if the computing system determines, in block 1214, that the fallback intent detection is indicative of positive intent, the method 1200 advances to block 1216 in which the computing system determines whether a field of view maximum has been reached (e.g., for the relevant side of the field of view). If so, the method 1200 advances to block 320. If not, the method 1200 advances to block 1218 in which the computing system increases the size of the intent field of view. As indicated above, in some embodiments, the computing system may increase the size of the intent field of view on the side from which the user approached by a predefined amount (e.g., 10 degrees). In block 1220, the computing system increments the session count and, in block 1222, the computing system compares the session count to a session limit. As indicated above, the learning phase may include a predefined number of UWB sessions or, more specifically, a predefined number of positive intent sessions, which may be defined as the session limit.

If the computing system determines, in block 1224, that the session limit has not been reached, the method 1200 returns to block 1204 of FIG. 12. However, if the computing system determines, in block 1224, that the session limit has been reached, the method 1200 advances to block 1226 in which the computing system stores the current intent field of view as the static field of view.

Although the blocks 1202-1226 are described in a relatively serial manner, it should be appreciated that various blocks of the method 1200 may be performed in parallel and/or in another order in some embodiments. As described above, in some embodiments, the computing system may subsequently re-execute the method 1200 in order to perform another learning phase. For example, in some embodiments, the computing system may periodically prompt the user to re-execute the method 1200, as the user's approach patterns may vary over time.

Referring now to FIG. 14, the access control device 102 may make an automated determination of a configuration for a UWB-based access control mode based on RADIO data. As shown in FIG. 14, the access control device 102 may be secured to a door 1402 that is positioned between structures 1404, 1406 (e.g., portions of the door jam or other aspects of the physical environment of the access control device 102). It should be appreciated that the structures 1404, 1406 may occlude the field of view of the UWB antenna of the access control device 102 as shown in FIG. 14. In the illustrative embodiment, the access control device 102 detects the occlusions using the RADAR data, and makes an automated determination of the field of view of the UWB antenna of the access control device 102 as having angles α₁ and α₂ relative to the center axis 1408.

Referring now to FIG. 15, the access control device 102 may generate a heat map indicative of a frequency of positive intent approaches of users to the access control device 102, and perform an automated configuration of the field of view for the UWB antenna of the access control device 102 based on the generated heat map. In some embodiments, the UWB antenna may be configured to be more sensitive if the user is approaching in/from hot grid cells and less sensitive if the user is approaching in/from cooler grid cells. FIG. 15 is an exemplary heat map, which depicts the user more frequently approaching from the right. In the illustrative embodiment, the grid elements of shade 1502 are indicative of the highest frequency of positive intent, the grid elements of shade 1508 are indicative of the lowest frequency of positive intent, the grid elements of shade 1504 are indicative of a frequency of positive intent that is less than those of shade 1502 but greater than those of shade 1506, and the grid elements of shade 1506 are indicative of a frequency of positive intent that is less than those of shade 1504 but greater than those of shade 1508.

What is claimed is:

1. A method for configuration of an ultra-wideband-based access control mode of an access control device, the method comprising:
determining, by a computing system, whether to configure the ultra-wideband-based access control mode for the access control device;
receiving, by the computing system, a user selection of a configuration type for the ultra-wideband-based access control mode in response to determining to configure the ultra-wideband-based access control mode for the access control device;
performing, by the access control device, automated configuration of the ultra-wideband-based access control mode in response to determining that user selection of the configuration type is an automated configuration; and
storing, by the access control device, manual configuration settings received from the user in response to determining that the user selection of the configuration type is a manual configuration.

2. The method of claim 1, wherein receiving the user selection of the configuration type for the ultra-wideband-based access control mode comprises receiving the user selection of the configuration type via a mobile device of the user, wherein a wireless communication connection is established between the mobile device and the access control device.

3. The method of claim 1, further comprising receiving the manual configuration settings from the user via user input on a mobile device of the user.

4. The method of claim 3, wherein the manual configuration settings comprise a user selection of an enabled field of view of an ultra-wideband antenna of the access control device.

5. The method of claim 4, wherein the enabled field of view of the ultra-wideband antenna of the access control device is user-selected via interaction with a plurality of discrete field of view regions, wherein user selection of each discrete field of view region of the plurality of field of view regions toggles a status of the respective discrete field of view region between enabled and disabled.

6. The method of claim 5, wherein the discrete field of view regions form a grid system.

7. The method of claim 4, wherein the enabled field of view of the ultra-wideband antenna of the access control device is adjustable by the user modifying the angular bounds of a displayed field of view indicator.

8. The method of claim 1, further comprising receiving the manual configuration settings from the user via a user interface on the access control device.

9. The method of claim 1, further comprising receiving the manual configuration settings from the user as a user selection of one of a plurality of predefined manual configuration settings.

10. The method of claim 1, wherein performing the automated configuration of the ultra-wideband-based access control mode comprises:
receiving radio detection and ranging (RADAR) data based on a physical environment of the access control device; and
configuring a field of view of an ultra-wideband antenna of the access control device based on the RADAR data.

11. The method of claim 1, wherein performing the automated configuration of the ultra-wideband-based access control mode comprises:
generating a heat map indicative of a frequency of positive intent approaches of users to the access control device; and
configuring a field of view of an ultra-wideband antenna of the access control device based on the heat map.

12. The method of claim 1, wherein performing the automated configuration of the ultra-wideband-based access control mode comprises performing intent detection during a learning phase to increase an enabled field of view of an ultra-wideband antenna of the access control device from an initial enabled field of view in response to determining that a positive intent session has occurred when the user is outside of the initial enabled field of view.

13. The method of claim 12, wherein performing the intent detection during the learning phase comprises performing the intent detection during a learning phase of a predefined number of positive intent sessions.

14. A computing system for configuration of an ultra-wideband-based access control mode of an access control device, the computing system comprising:
at least one processor; and
at least one memory comprising a plurality of instructions stored thereon that, in response to execution by the at least one processor, cause the computing system to:
determine whether to configure the ultra-wideband-based access control mode for the access control device;
receive a user selection of a configuration type for the ultra-wideband-based access control mode in response to a determination to configure the ultra-wideband-based access control mode for the access control device;
perform automated configuration of the ultra-wideband-based access control mode in response to a determination that user selection of the configuration type is an automated configuration; and
store manual configuration settings received from the user in response to a determination that the user selection of the configuration type is a manual configuration.

15. The computing system of claim 14, further comprising receiving the manual configuration settings from the user via user input on a mobile device of the use, wherein the manual configuration settings comprise a user selection of an enabled field of view of an ultra-wideband antenna of the access control device.

16. The computing system of claim 15, wherein the enabled field of view of the ultra-wideband antenna of the access control device is user-selected via interaction with a plurality of discrete field of view regions, wherein user selection of each discrete field of view region of the plurality of field of view regions toggles a status of the respective discrete field of view region between enabled and disabled.

17. The computing system of claim 14, wherein performing the automated configuration of the ultra-wideband-based access control mode comprises:
receiving radio detection and ranging (RADAR) data based on a physical environment of the access control device; and
configuring a field of view of an ultra-wideband antenna of the access control device based on the RADAR data.

18. The computing system of claim 14, wherein performing the automated configuration of the ultra-wideband-based access control mode comprises:
generating a heat map indicative of a frequency of positive intent approaches of users to the access control device; and
configuring a field of view of an ultra-wideband antenna of the access control device based on the heat map.

19. The computing system of claim 14, wherein performing the automated configuration of the ultra-wideband-based access control mode comprises performing intent detection during a learning phase to increase an enabled field of view of an ultra-wideband antenna of the access control device from an initial enabled field of view in response to determining that a positive intent session has occurred when the user is outside of the initial enabled field of view.

20. The computing system of claim 19, wherein performing the intent detection during the learning phase comprises performing the intent detection during a learning phase of a predefined number of positive intent sessions.
